(19) United States
(12) Patent Application Publication
(10) Pub. No.: US 2025/0187948 A1
(43) Pub. Date: Jun. 12, 2025

(54) ALGINATE-GRAPHENE OXIDE HYDROGEL

(71) Applicant: Khalifa University of Science and Technology, Abu Dhabi (AE)

(72) Inventors: Linda Yuan ZOU, Abu Dhabi (AE); Adetunji ALABI, Abu Dhabi (AE)

(21) Appl. No.: 18/846,502

(22) PCT Filed: Feb. 8, 2023
(86) PCT No.: PCT/IB2023/051125

§ 371 Date: Sep. 12, 2024

Related U.S. Application Data
(60) Provisional application No. 63/319,668, filed on Mar. 14, 2022.

(51) Int. Cl. C02F 1/44; B01D 69/14; B01D 71/02; B01D 71/08; B01D 71/10; B01D 71/40; C08J 3/075

(52) U.S. Cl. CPC C02F 1/44; B01D 69/14111; B01D 71/0211; B01D 71/08; B01D 71/10; B01D 71/401; C08J 3/075; C02F 2305/08

(57) ABSTRACT

A device (100) for water purification includes one or more first layers (110) including a semipermeable membrane and one or more second layers (120) in contact with the one or more first layers (110), wherein the one or more second layers (120) include an alginate hydrogel and are sufficient to draw water across the one or more first layers (110).

### CROSS-REFERENCE TO RELATED APPLICATION

This application claims benefit of U.S. Provisional Application No. 63/319,668 filed on Mar. 14, 2022. U.S. Provisional Application No. 63/319,668 is incorporated herein by reference. A claim of priority is made.

### BACKGROUND

Hydrogels are synthetic or natural materials made up of polymer chains that are cross-linked by either physical or chemical bonds and are able to entrap large volumes of water courtesy of the high concentration of hydrophilic groups present in their polymer chains. An important characteristic of hydrogels is their ability to go through reversible volume change in response to changes in external stimuli. Some of the stimuli that have been used to produce desired changes in hydrogel systems are temperature, electric fields, hydrostatic pressure, pH, light, and solution concentration. Hydrogels have been successfully used in numerous applications such as tissue engineering and regenerative medicine, drug delivery, biosensors, food, agriculture, water treatment, and energy applications. There remains a need for hydrogels obtained from natural materials and efficient hydrogels for water purification.

### SUMMARY

According to one aspect, a device for water purification includes one or more first layers including a semipermeable membrane and one or more second layers in contact with the one or more first layers, wherein the one or more second layers include an alginate hydrogel and are sufficient to draw water across the one or more first layers.

According to another aspect, a method of making a hydrogel includes contacting a first solution with calcium chloride to form a second solution and curing the second solution sufficient to form a hydrogel, wherein the first solution includes sodium alginate solution.

According to another aspect, a method of water purification includes providing a semipermeable membrane in contact with one or more hydrogel layers and drawing unpurified water from a water source across the semipermeable membrane sufficient to purify the unpurified water, wherein the one or more hydrogel layers include alginate and are more hydrophilic than the semipermeable membrane.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates a device 100 for water purification, according to some embodiments.

FIG. 2 illustrates a device 200 for water purification, according to some embodiments.

FIG. 3 illustrates a method 300 of making a hydrogel, according to some embodiments.

FIG. 4 illustrates a method 400 of water purification, according to some embodiments.

FIG. 5 illustrates a schematic of a pure alginate hydrogel (P-HG) drawing water by contacting an osmotic membrane, according to some embodiments.

FIG. 6 illustrates a schematic of an alginate-graphene oxide hydrogel (GO-HG) drawing water by contacting an osmotic membrane, according to some embodiments.

FIG. 7 illustrates a schematic of a synthesis method for hydrogels, according to some embodiments.

FIG. 8A illustrates a P-HG hydrogel sample, according to some embodiments.

FIG. 8B illustrates a GO-HG hydrogel sample, according to some embodiments.

FIG. 9 illustrates a schematic of hydrogel water uptake tests, according to some embodiments.

FIG. 10 illustrates a schematic of hydrogel water production tests, according to some embodiments.

FIG. 11 illustrates test cell components and assembly, according to some embodiments.

FIG. 12A illustrates an SEM image for a P-HG hydrogel, according to some embodiments.

FIG. 12B illustrates an SEM image for a P-HG hydrogel, according to some embodiments.

FIG. 12C illustrates an SEM image for a GO-HG hydrogel, according to some embodiments.

FIG. 12D illustrates an SEM image for a GO-HG hydrogel, according to some embodiments.

FIG. 13A illustrates an AFM image of a GO-HG hydrogel, according to some embodiments.

FIG. 13B illustrates an AFM image of a GO-HG hydrogel, according to some embodiments.

FIG. 13C illustrates an AFM image of a P-HG hydrogel, according to some embodiments.

FIG. 13D illustrates an AFM image of a P-HG hydrogel, according to some embodiments.

FIG. 14A illustrates a micrograph from E-SEM tests with a dry GO-HG hydrogel before the test, according to some embodiments.

FIG. 14B illustrates a micrograph from E-SEM tests with a wet GO-HG hydrogel during the test, according to some embodiments.

FIG. 14C illustrates a micrograph from E-SEM tests with a dry P-HG hydrogel before the test, according to some embodiments.

FIG. 14D illustrates a micrograph from E-SEM tests with a wet P-HG hydrogel during the test, according to some embodiments.

FIG. 15 illustrates the water contact angle results for P-HG and GO-HG hydrogels, according to some embodiments.

FIG. 16 illustrates water uptake results for P-HG and GO-HG hydrogels, according to some embodiments.

FIG. 17A illustrates Raman spectra for the GO, GO-HG, and P-HG hydrogel samples, according to some embodiments.

FIG. 17B illustrates FTIR spectra for the GO, GO-HG, and P-HG hydrogel samples, according to some embodiments.

FIG. 18 illustrates water production results for the GO-HG and the P-HG hydrogels, according to some embodiments.

### DETAILED DESCRIPTION

### Definitions

As used herein, the term “contaminants” may include one or more of bacteria, pathogens, viruses, and organic materials.

As used herein, the term “unpurified water” includes water with a high concentration of contaminants and/or salt such as seawater. Unpurified water may not be suitable or ideal for human consumption. Unpurified water may include greater than about 2 wt % salt.

As used herein, the term “purified water” may include water with a much lower concentration of contaminants and/or salts compared to the unpurified water. Purified water may be suitable for human consumption. In one example, purified water may be over 95% salt-free and/or contaminant free. In another example, purified water may include water with less than 200 mg/L of sodium chloride. In yet another example, purified water may include water with less than 100 mg/L of sodium chloride. Purified water in an industrial process may be suitable for reuse by one or more process units.

### Discussion

Embodiments of the present disclosure describe a novel approach to capture and filter water with hydrogels. Efficient, hydrophilic hydrogels can be utilized to draw water across a membrane. These hydrogels can be natural, non-toxic, and biodegradable. Further, these hydrogels can include nanomaterials to increase the flowrate and efficiency of water purification. Embodiments of the present disclosure can be utilized for efficient water purification in small and large applications. Further, water can be purified without any external energy sources.

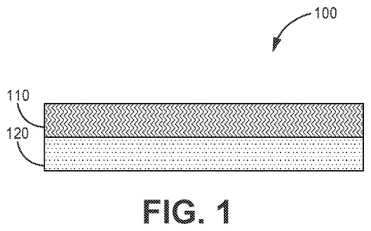

FIG. 1 illustrates a device 100 for water purification, according to some embodiments. FIG. 1 includes the device 100, a first layer 110, and a second layer 120. Device 100 may be used to filter, purify, desalinate, and uptake liquids or vapors such as water, which may be initially unpurified. Device 100 may be used to purify tap water into fresh drinking water. In one example, device 100 may be utilized without any electricity or pumps. For example, device 100 can release purified water from the second layer 120 itself, which can be assisted by gravity. In another example, device 100 may be utilized in conjunction with an electric or manual pump to increase the flow rate of liquid through device 100. In this example, the pump may be a mechanical pump. Further, device 100 may be operated without an additional dewatering step. The size and thickness of device 100 may be tuned to increase the water production rate.

The first layer 110 may be in contact with the second layer 120. Second layer 120 may be hydrophilic and sufficient to draw water through the first layer 110 without any additional components by attracting water molecules. In one example, second layer 120 has a high osmotic pressure. The driving force of water can be induced by the surface energy gradient of the first layer 110 and the second layer 120. Second layer 120 may have a higher surface energy or higher chemical potential compared to the water contacting the other side of first layer 110. The diameters of the first layer 110 and the second layer 120 may be substantially similar. For example, the diameters of the first layer 110 and the second layer 120 may range from about 1 cm to about 50 cm. In another example, the diameters of the first layer 110 and the second layer 120 may be about 5 cm. The diameter may increase or decrease depending on the application and the desired flow-rate of purified water. The diameter of the second layer 120 may be any diameter sufficient to draw water through the first layer 110.

In one example, the first layer 110 includes a semipermeable membrane such as a thin film membrane, tubular membrane, hollow-fiber, and flat-sheet. The semipermeable membrane may be any membrane sufficient for forward osmosis. In another example, the first layer 110 may include a forward osmosis osmotic membrane such as cellulose triacetate for purifying water. For example, the first layer 110 may include a highly selective flat sheet cellulose triacetate osmotic membrane. The first layer 110 may have a pore size sufficient to remove dissolved solids and impurities from liquids. Further, the first layer 110 may be sufficient to process precipitating salts and polymerized organics. The first layer 110 may be any thickness sufficient to purify or filter liquids. For example, the first layer 110 may have a thickness ranging from about 10 μm to about 1 mm. The first layer 110 may have a thickness ranging from about 50 μm to about 300 μm. In one example, the first layer 110 may have an operating pH range of 3-7 pH and operate from 0-75 psi.

In one example, the second layer 120 includes an alginate hydrogel with an interconnected porous network. For example, the second layer 120 may include a calcium alginate hydrogel. An alginate hydrogel can absorb and retain large amounts of water. The second layer 120 may include one or more of nanosheets and nanoparticles. For example, the second layer 120 may include graphene oxide nanoparticles. In addition, or alternatively, the second layer 120 may include graphene oxide nanosheets. Graphene oxide nanoparticles and/or nanosheets may be utilized due to the hydrophilic nature of the nanomaterial and the ease of dispersing the nanomaterial in an aqueous medium. Graphene oxide nanosheets can increase the hydrophilic functional sites and increase the connectivity in the second layer 120. Graphene oxide nanosheets in the second layer 120 can provide increased structured channels for water flow. Importantly, these graphene oxide nanosheets can enhance the water production capability without compromising the physical strength of the second layer 120.

The second layer 120 may include one or more synthetic or natural polyelectrolytes. For example, the second layer 120 may include an anionic or cationic polyelectrolyte. The second layer 120 may include an anionic polymer with a negative charge in a water solution, such as polyacrylic acid (PAA). Many side chains of anionic polymers such as polyacrylic acid may be deprotonated and display a negative charge. Anionic polymers such as deprotonated polyacrylic acid can absorb and retain water. Further, anionic polymers such as deprotonated polyacrylic acid can enhance the overall chemical potential of device 100. Anionic polymers such as polyacrylic acid may have a permanent chemical potential and can assist in drawing water across the first layer 110.

The second layer 120 may have a reversible swollen volume in response to external environmental stimuli, including temperature, light, pressure, solvent composition, and pH. Importantly, the second layer 120 may be natural and non-toxic. The second layer 120 may be any thickness sufficient to draw water across the first layer 110. In one example, the thickness of the second layer 120 may range from about 1 mm to about 10 cm. In another example, the thickness of the second layer 120 may range from 0.5 cm to 3 cm. In yet another example, the thickness of the second layer 120 may range from 1 cm to 2 cm. Additionally, the surface area of the second layer 120 may be tuned according to the application and desired water production rate. For a more portable, small-scale application, a decreased surface area of the second layer 120 may be utilized. The second layer 120 may have a cross-sectional shape of a circle, polygon, rectangle, square, or triangle. In one non-limiting example, the second layer 120 is substantially shaped like a cylinder. Importantly, device 100 may be natural, non-toxic, and biodegradable.

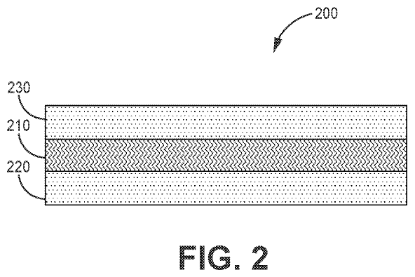

FIG. 2 illustrates a device 200 for water purification, according to some embodiments. FIG. 2 includes the device 200, a first layer 210, a second layer 220, and a third layer 230. Device 200 may be used to filter, purify, desalinate, and uptake liquids or vapors such as water, which may be unpurified to start. In one example, the first layer 210 includes an osmotic membrane, the second layer 220 includes an alginate-based hydrogel, and the third layer 230 includes an alginate-based hydrogel. Since ambient air and the atmosphere hold large amounts of water in the form of vapor or fine droplets, device 200 can be utilized to capture water from the ambient air and/or the atmosphere.

Device 200 may be used to purify tap water into fresh drinking water. In one example, device 200 may be utilized without an electricity or pumps and may continuously operate. In another example, device 200 may be utilized in conjunction with an electric or manual pump to increase the flow rate of liquid through device 200. In this example, the pump may be a mechanical pump. Further, device 200 may be operated without an additional dewatering step.

The first layer 210 may be in contact with both the second layer 220 and the third layer 230. The second layer 220 may be on the opposite side of the first layer 210 from the third layer 230. Second layer 220 may be hydrophilic and sufficient to draw water through the first layer 210 without any additional components by attracting water molecules. In one example, second layer 220 has a high osmotic pressure. The driving force of water can be induced by the surface energy gradient of the first layer 210 and the second layer 220. Second layer 220 may have a higher surface energy or higher chemical potential compared to the liquid water in first layer 210. The diameters of the first layer 210, the second layer 220, and the third layer 230 may be substantially similar. For example, the diameters of the first layer 210, the second layer 220, and the third layer 230 may range from about 1 cm to about 50 cm. For example, the diameters of the first layer 210, the second layer 220, and the third layer 230 may be about 5 cm. The diameter may increase or decrease depending on the application and the desired flow-rate of purified water. The diameter may be any diameter sufficient to draw water across the first layer 210. The third layer 230 may be directly in contact with water or air. The third layer 230 may capture water from water or the atmosphere. Once captured by the third layer 230, the second layer 220 can draw accumulated water across the first layer 210. A vacuum pump can be utilized to assist in drawing wet air through the third layer 230. Device 200 can be utilized for different atmospheric capture rates.

In one example the first layer 210 includes a semipermeable membrane. In another example, the first layer 210 may include an osmotic membrane such as cellulose triacetate. For example, the first layer 210 may include a highly selective flat sheet cellulose triacetate osmotic membrane. The first layer 210 may be sufficient to remove dissolved solids and impurities from liquids. Further, the first layer 210 may be sufficient to process precipitating salts and polymerized organics. The first layer 210 may be any thickness sufficient to purify or filter liquids. For example, the first layer 210 may have a thickness ranging from about 10 μm to about 1 mm. The first layer 210 may have a thickness ranging from about 50 μm to about 300 μm. In one example, the first layer 210 may have an operating pH range of 3-7 pH and operate from 0-75 psi.

In one example, the second layer 220 includes an alginate-based hydrogel with an interconnected porous network. For example, the second layer 220 may include a calcium alginate hydrogel. An alginate hydrogel can absorb and retain large amounts of water. The second layer 220 may include one or more of nanosheets and nanoparticles. For example, the second layer 220 may include graphene oxide nanoparticles. In addition or alternatively, the second layer 220 may include graphene oxide nanosheets. Graphene oxide nanosheets may be utilized due to the hydrophilic nature of the nanosheets and the ease of dispersing the nanosheets in an aqueous medium. Graphene oxide nanosheets can increase the hydrophilic functional sites and increase the connectivity in the second layer 220. Graphene oxide nanosheets in the second layer 220 can provide increased structured channels for water flow. Importantly, these graphene oxide nanosheets can enhance the water drawing capability without compromising the physical strength of the second layer 220.

The second layer 220 may include an anionic polymer with a negative charge in a water solution, such as polyacrylic acid (PAA). Many side chains of polyacrylic acid may be deprotonated and display a negative charge. Deprotonated polyacrylic acid can absorb and retain water. Further, deprotonated polyacrylic acid can enhance the overall chemical potential of device 200. Polyacrylic acid may have a permanent chemical potential and can assist in drawing water across the first layer 210.

The second layer 220 may have a reversible swollen volume in response to external environmental stimuli, including temperature, light, pressure, solvent composition, and pH. Importantly, the second layer 220 may be natural and non-toxic. The second layer 220 may be any thickness sufficient to draw water across the first layer 210. In one example, the thickness of the second layer 220 may range from about 1 mm to about 10 cm. In another example, the thickness of the second layer 220 may range from 0.5 cm to 3 cm. In yet another example, the thickness of the second layer 220 may range from 1 cm to 2 cm. Additionally, the surface area of the second layer 220 may be tuned according to the particular application. For a more portable, small-scale application, a decreased surface area of the second layer 220 may be utilized. The second layer 220 may have a cross-sectional shape of a circle, polygon, rectangle, square, or triangle. In one non-limiting example, the second layer 220 is substantially shaped like a cylinder.

In one example, the third layer 230 includes an alginate-based hydrogel with an interconnected porous network. For example, the third layer 230 may include a calcium alginate hydrogel. An alginate hydrogel can absorb and retain large amounts of water. The third layer 230 may include one or more of nanosheets and nanoparticles. For example, the third layer 230 may include graphene oxide nanoparticles. In addition, or alternatively, the third layer 230 may include graphene oxide nanosheets. Graphene oxide nanosheets may be utilized due to the hydrophilic nature of the nanosheets and the ease of dispersing the nanosheets in an aqueous medium. Graphene oxide nanosheets can increase the hydrophilic functional sites and increase the connectivity in the third layer 230. Graphene oxide nanosheets in the third layer 230 can provide increased structured channels for water flow. Importantly, these graphene oxide nanosheets can enhance the water drawing capability without compromising the physical strength of the third layer 230. The third layer 230 may include an anionic polymer with a negative charge in a water solution, such as polyacrylic acid (PAA).

The third layer 230 may have a reversible swollen volume in response to external environmental stimuli, including temperature, light, pressure, solvent composition, and pH. Importantly, the third layer 230 may be natural and non-toxic. The third layer 230 may be any thickness sufficient to draw water from the atmosphere or from a water source. In one example, the thickness of the third layer 230 may range from about 1 mm to about 10 cm. In another example, the thickness of the third layer 230 may range from 0.5 cm to 3 cm. In yet another example, the thickness of the third layer 230 may range from 1 cm to 2 cm. Additionally, the surface area of the third layer 230 may be tuned according to the particular application. For a more portable, small-scale application, a decreased surface area of the third layer 230 may be utilized. The third layer 230 may have a cross-sectional shape of a circle, polygon, rectangle, square, or triangle. In one non-limiting example, the third layer 230 is substantially shaped like a cylinder.

Importantly, device 200 with third layer 230 may increase the water production in certain applications. For example, third layer 230 may be utilized to increase water production from ambient and/or atmospheric air. The third layer 230 may be directly exposed to the air and can absorb the water vapor or moisture in the environment. In this way, atmospheric water is captured by hydrogel and drawn through the osmotic membrane by the second layer 220.

Since device 100 and device 200 can be operated without a pump, the pressure will be decreased, which can reduce possible fouling. Further, any possible fouling will be on the feed side and not the purified water side. The layers in device 100 and device 200 may be washed with water or acetic acid for cleaning and removing fouling if necessary. Hydrogels normally need heat or pressure to release water. Importantly, device 100 and device 200 are capable of releasing water without any extra stimuli such as a pH change, heat, or squeezing.

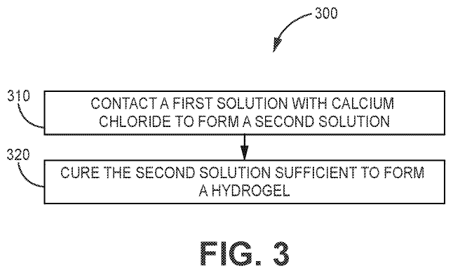

Referring to FIG. 3, a method 300 of making a hydrogel is illustrated. The method 300 includes the following steps:

STEP 310, CONTACT A FIRST SOLUTION WITH CALCIUM CHLORIDE TO FORM A SECOND SOLUTION, includes contacting a first solution with calcium chloride to form a second solution, wherein the first solution includes sodium alginate solution. Alternatively, or in addition to the calcium chloride, other metal ions may be utilized and contacted with the first solution. For example, magnesium ions from magnesium chloride may be utilized. In one example, calcium chloride may be utilized as it gels faster at higher concentrations. Calcium ions from other metal salts may be utilized. Sodium alginate solution may be prepared by dissolving sodium alginate powder in deionized water. In one example, the concentration of sodium alginate in the sodium alginate solution ranges from about 0.5% w/v to about 10% w/v. In another example, the concentration of sodium alginate in the sodium alginate solution ranges from about 0.75% w/v to about 4% w/v. In yet another example, the concentration of sodium alginate in the sodium alginate solution is about 1% w/v. The concentration of sodium alginate in the sodium alginate solution may be increased or decreased to sufficiently form the first solution. In one example, the concentration of calcium chloride ranges from about 0.5% w/v to about 15% w/v. In another example, the concentration of calcium chloride ranges from about 2.5% w/v to about 7.5% w/v. In yet another example, the concentration of calcium chloride is about 5% w/v. The concentration of calcium chloride may be increased or decreased as desired. For example, calcium may be part of a reaction as a catalyst and may not be exchanged. In this case, the calcium chloride may be increased or decreased to sufficiently catalyze a reaction.

The first solution may also include a graphene oxide dispersion. Graphene oxide can be prepared using a modified Hummers method. In one example, sulfuric acid can be cooled, and graphite flakes and sodium nitrate can be added to the cooled sulfuric acid to form a solution. After, potassium permanganate can be added to the solution. The solution can be stirred and transferred to an ice bath. After, deionized water can be added, and the solution can be stirred at room temperature. Then, deionized water can be added to the solution followed by the dropwise addition of hydrogen peroxide. The solution can be vacuum filtered and washed, and the recovered graphite oxide cake may be washed with hydrochloric acid solution and vacuum filtered again. The mud can then be washed with deionized water until the pH rises. Finally, the graphite oxide may be diluted with deionized water and exfoliated with a probe ultrasonicator to produce graphene oxide nanosheets.

In one example, a graphene oxide dispersion with a concentration ranging from 1 g/L to 50 g/L is mixed with the sodium alginate solution. In another example, a graphene oxide dispersion with a concentration ranging from 5 g/L to 15 g/L is mixed with the sodium alginate solution. In yet another example, a graphene oxide dispersion with a concentration of about 10 g/L is mixed with the sodium alginate solution. The graphene oxide can be uniformly mixed with the sodium alginate in the first solution. Contacting can include mixing, pouring, or otherwise placing the solutions in contact.

The first solution may further include an anionic polymer such as polyacrylic acid. Many side chains of polyacrylic acid may be deprotonated and display a negative charge. Deprotonated polyacrylic acid can absorb and retain water. In one example, polyacrylic acid with a molecular weight ranging from about 40,000 g/mol to about 110,000 g/mol may be utilized. In another example, polyacrylic acid solution may have a concentration of about 0.05 M to about 0.2 M. The first solution may have a set pH value for curing, such as about 7 pH;

STEP 320, CURE THE SECOND SOLUTION SUFFICIENT TO FORM A HYDROGEL, includes curing the second solution for a certain amount of time sufficient to form a hydrogel. Curing can be completed at room temperature or at a temperature above or below room temperature. Curing can include toughening by cross-linking of the polymer chains. In one example, curing can occur for 1 hour to 30 hours. In another example, curing can occur for 15 hours to 25 hours. In yet another example, curing can occur for about 20 hours. After curing, the formed hydrogel can optionally be rinsed with deionized water. The formed hydrogel can be cut into a specific shape depending on the desired application.

Method 300 can be utilized to make a hydrogel for water purification and desalination. Further, method 300 utilizes natural materials for the hydrogel fabrication. Method 300 allows for a wide range of shapes and sizes of the formed hydrogels and can be efficiently completed in few steps.

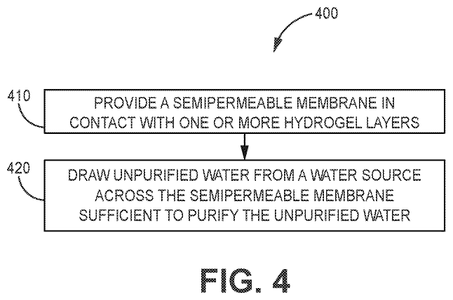

Referring to FIG. 4, a method 400 of water purification is illustrated. The method 400 includes the following steps:

STEP 410, PROVIDE A SEMIPERMEABLE MEMBRANE IN CONTACT WITH ONE OR MORE HYDROGEL LAYERS, includes providing a semipermeable membrane, such as semipermeable osmotic membrane, in contact with one or more hydrogel layers. The semipermeable membrane can include cellulose triacetate or other suitable forward osmosis membranes. In one example, the semipermeable membrane is a flat sheet cellulose triacetate osmotic membrane. The one or more hydrogel layers may be an alginate-based hydrogel with an interconnected porous network. The one or more hydrogel layers may include calcium alginate. The one or more hydrogel layers may include one or more of nanosheets and nanoparticles. In this example, the nanosheets or nanoparticles may include graphene oxide. Graphene oxide nanomaterial may be utilized due to the hydrophilic nature of the nanomaterial and the ease of dispersing the nanomaterial in an aqueous medium. Graphene oxide nanosheets can increase the hydrophilic functional sites and increase the connectivity in the one or more hydrogel layers. Importantly, these graphene oxide nanosheets can enhance the water drawing capability without compromising the physical strength of the one or more hydrogel layers. The one or more hydrogel layers may further include polyacrylic acid, such as deprotonated polyacrylic acid.

If the one or more hydrogel layers includes two or more layers, one layer can be on each side of the semipermeable membrane. The one or more hydrogel layers may have a diameter greater than 4 cm. The one or more hydrogel layers may have a diameter greater than 15 cm. The one or more hydrogel layers may be in contact with the water source or air source. The air source can be ambient or atmospheric air including water vapor or fine water droplets;

STEP 420, DRAW UNPURIFIED WATER FROM A WATER SOURCE ACROSS THE SEMIPERMEABLE MEMBRANE SUFFICIENT TO PURIFY THE WATER, includes drawing unpurified water, such as liquid water or water vapor, across the semipermeable membrane sufficient to purify the water, wherein the one or more hydrogel layers include alginate and are more hydrophilic than the semipermeable membrane. In one example, the water source may be one or more of air, water, seawater, unpurified water, and salt water. The unpurified water can be present as a liquid or be water vapor in the atmosphere. The semipermeable membrane can be directly in contact with the unpurified water source or the atmospheric air. The one or more hydrogel layers is sufficient to draw unpurified water across the semipermeable membrane. Additionally, a pump can be used to draw additional water across the semipermeable membrane. This pump may be an electric or manual pump.

Optionally, calcium chloride solution or other ionic solutions/electrolytes can be added to the one or more hydrogel layers and the semipermeable membrane to induce a concentration gradient to initiate water transport from the water side of the semipermeable membrane to the side with hydrogel. By adding calcium chloride, the water chemical potential on the surface of the one or more hydrogel layers is reduced, thus initiating water transport through the semipermeable membrane. Further, calcium chloride solution can be utilized as this can be included in drinking water. Anionic polymers such as polyacrylic acid that may be included in the one or more hydrogel layers may enhance the overall chemical potential of the hydrogel. Anionic polymers such as polyacrylic acid may have a permanent chemical potential or equivalent osmotic pressure and can start the water drawing process without additional osmotic agents.

Method 400 provides a method of efficiently purifying water from a water source. Importantly, method 400 can be utilized with or without any external energy sources. In one example, method 400 may be utilized for small and large-large scale water purification applications. For example, method 400 may be utilized for small-scale applications such as personal drinking water and large-scale applications such as an industrial process or industrial water desalination and purification. Method 400 can use natural materials to purify water moving across the semipermeable membrane. Method 400 may be utilized to remove over 99% of contaminants from unpurified water. Method 400 may use device 100 or device 200 to purify water.

### Example 1

Alginate-GO (graphene oxide) hydrogels were synthesized, and the purified water production through a membrane was assessed. Calcium alginate hydrogels (P-HG) and GO-incorporated alginate hydrogels (GO-HG) were synthesized, characterized, and used in bench-scale water production feasibility tests. These hydrogels are eco-friendly and nature-inspired. Furthermore, they are reusable without the need for a recovery/regeneration step. Materials utilized include calcium chloride (CaCl₂)), sodium alginate (Na alginate), potassium permanganate (KMnO₄), sodium nitrate (NaNO₃), hydrogen peroxide (H₂O₂), hydrochloric acid (HCl), sulfuric acid (H₂SO₄), and deionized water (DI H₂O). Graphite flakes and a flat sheet CTA osmotic FO membrane were also utilized.

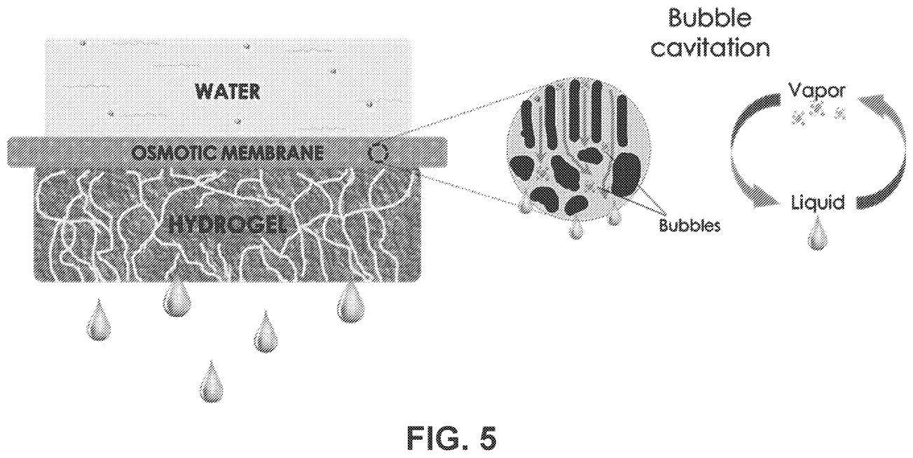

FIG. 5 illustrates a schematic of a P-HG hydrogel drawing water by contacting an osmotic membrane, according to some embodiments. FIG. 5 shows water, an osmotic membrane, and a hydrogel. The hydrogel has an interconnected porous network for the water to flow through. Further, the hydrogel draws the water through the osmotic membrane.

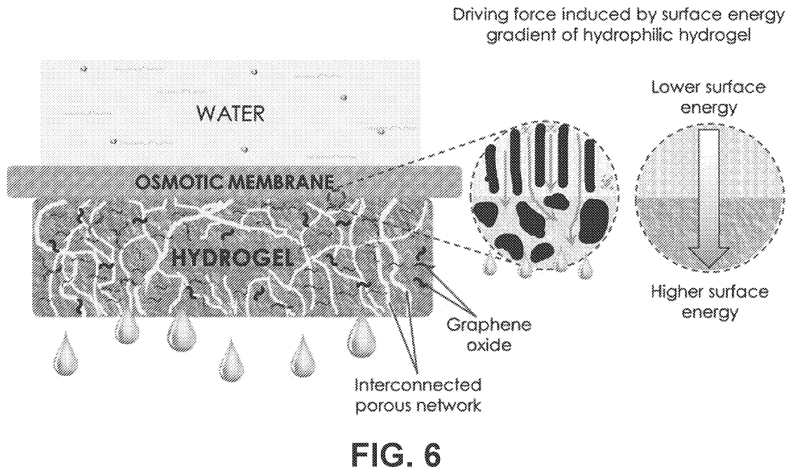

FIG. 6 illustrates a schematic of a GO-HG hydrogel drawing water by contacting an osmotic membrane, according to some embodiments. FIG. 6 shows water, an osmotic membrane, and a hydrogel with graphene oxide. As shown in FIG. 6, the hydrogel has a higher surface energy compared to the osmotic membrane. This is the driving force for moving water across the membrane. In one example, the hydrogel is more hydrophilic than the osmotic membrane. Further, less cavitation is present in the alginate hydrogel containing graphene oxide compared to the pure alginate hydrogel.

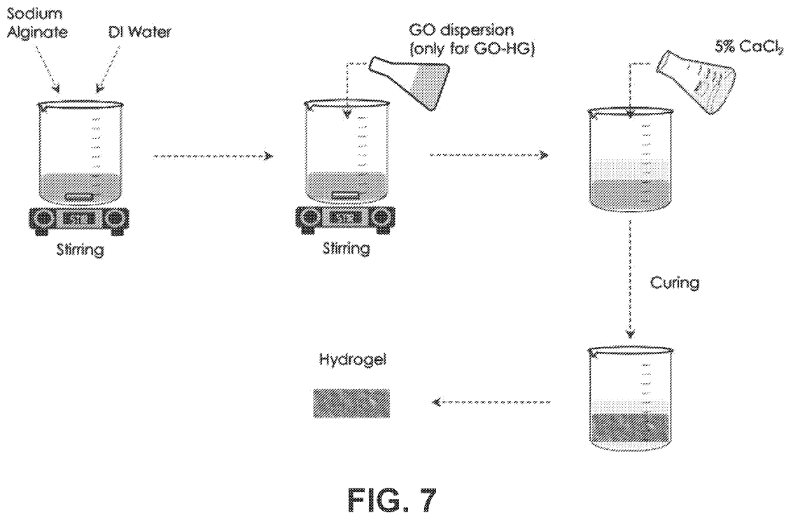

FIG. 7 illustrates a schematic of a synthesis method for hydrogels, according to some embodiments. Sodium alginate solution (1% w/v) was prepared by dissolving 10 g of sodium alginate powder in 990 mL of DI H₂O. FIG. 7 illustrates the optional step of adding a GO dispersion while stirring the solution. Then, 100 mL of the sodium alginate solution was transferred to a beaker. 40 mL of CaCl₂ (5% w/v) was poured into 100 mL of the sodium alginate solution (1% w/v), and then the alginate was left to cure (i.e., toughen by cross-linking of the polymer chains) at room temperature for 20 hours. The resultant hydrogel was then recovered and rinsed with DI H₂O.

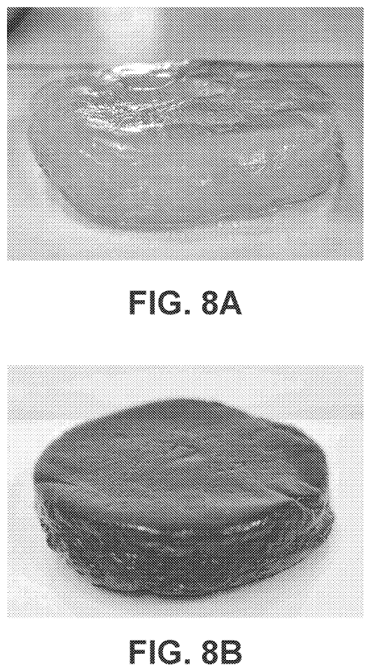

FIG. 8A illustrates a P-HG hydrogel sample, according to some embodiments. FIG. 8B illustrates a GO-HG hydrogel sample, according to some embodiments. A round cookie cutter (5 cm diameter) was used to cut out a piece of the pure hydrogel for water production trials. This was to ensure that the hydrogels used for the water production trials had a uniform surface area (ca. 19.63 cm²). GO was prepared using a modified Hummers method. Briefly, 250 mL of H₂SO₄ was cooled to about 4° C. in an ice bath. This was followed by the addition of 2 g of graphite flakes and 1 g of NaNO₃ to the cooled H₂SO₄.

The formed solution was stirred to achieve uniform mixing. 12 g of KMnO₄ was slowly added to the solution. Thereafter, the solution was continuously stirred for 45 minutes in an ice bath. The solution was transferred to a water bath and stirred continuously for 2 hours at 35° C. Then, the solution was placed in an ice bath with continuous stirring applied. After, 250 mL of DI H₂O was slowly added to the solution. The solution was removed from the ice bath and stirred at room temperature for 2 hours. Then, 500 mL of DI H₂O was poured at once into the solution. This was followed by the dropwise addition of H₂O₂ till the solution turned golden yellow in color. The solution was then filtered in a vacuum filtration setup. The recovered graphite oxide cake was washed with 400 mL of HCl solution (1:10 vol %) and then vacuum filtered (this step was performed twice). The mud was then washed with DI H₂O till the pH rose was 6.5. Finally, the graphite oxide was diluted with DI H₂O and then exfoliated with a probe ultrasonicator to produce GO nanosheets.

GO dispersion (10 g/L) was mixed with sodium alginate solution till a uniform solution was obtained. Then, 40 mL of CaCl₂ (5% w/v) was poured into 100 mL of the resultant GO-sodium alginate solution and left to cure for 20 hours. Just as with the pure hydrogel, the formed GO-HG hydrogel was cut with a round cookie cutter (5 cm diameter). This cut GO-HG piece (surface area ca. 19.63 cm²) was used in the water production trials. The formulations of the starting and curing solutions are shown in Table 1.

TABLE 1
Composition of P-HG and GO-HG Hydrogels

| | Starting Solution | | | Curing |
|---|---|---|---|---|
| | Sodium | | | Solution |
| | alginate | DI H₂O | GO | 5% CaCl₂ |
| Hydrogel/component | (g) | (mL) | (g) | (mL) |
| Pure HG | 1 | 99 | 0 | 100 |
| GO-HG | 1 | 99 | 0.25 | 100 |

The surface of the GO-HG hydrogel appeared to have a rougher morphology than that of the P-HG hydrogel owing to the presence of the additional 2D material (i.e., GO nanosheets) in GO-HG. A 20 wt % GO content resulted in significant differences in physical appearance and surface morphology. The GO-HG sample displayed a blackish color compared to the translucent pale color of the P-HG sample.

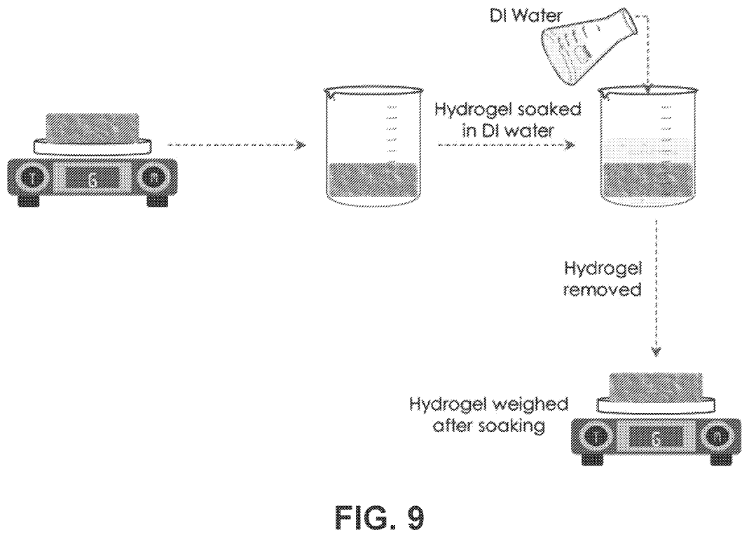

FIG. 9 illustrates a schematic of hydrogel water uptake tests, according to some embodiments. Water uptake tests were carried out by first weighing the hydrogel and then immersing the hydrogel in 500 mL of DI H₂O for 24 hours, followed by measuring the weight of the hydrogels. The water uptake is calculated according to Equation 1.

$$water uptake = \frac{{W}_{f} - {W}_{i}}{{W}_{i}} \times 100 \% \qquad ( 1 )$$

where W_{f} is the weight of the hydrogel after soaking, and Wᵢ is the weight of the hydrogel before soaking. This cycle was repeated for a total of 22 days, and the cumulative water uptake for each hydrogel sample was calculated at the end of the tests.

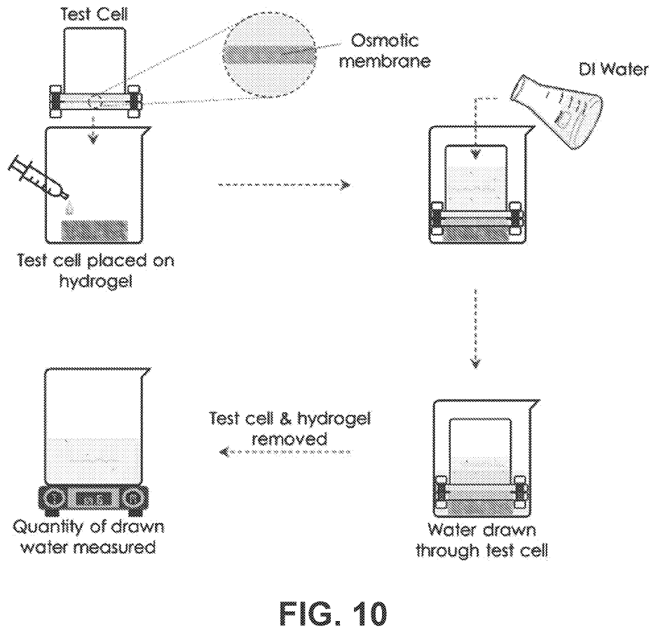

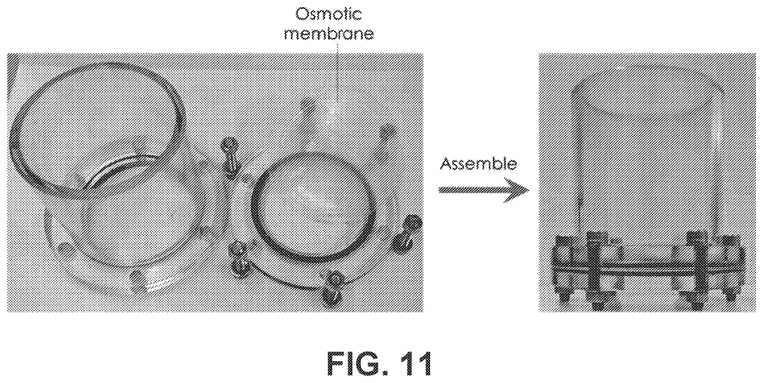

FIG. 10 illustrates a schematic of hydrogel water production tests, according to some embodiments. FIG. 11 illustrates test cell components and assembly, according to some embodiments. First, a piece of hydrogel sample was placed in an empty beaker. Afterwards, a piece of the osmotic membrane was assembled in the test cell. The assembled test cell was then placed on top of the hydrogel to ensure close contact between the hydrogel and the osmotic membrane. Lastly, the test cell was filled with 300 mL of DI H₂O. The setup was left undisturbed for 20 hours, after which the quantity of free water in the beaker drawn by the hydrogel was measured. The water production test was repeated 2 more times for each hydrogel sample. Before each test, 3 mL of CaCl₂) was poured on the hydrogel samples. CaCl₂) solution was added to induce a concentration gradient, which initiated water transport from the DI H₂O side of the membrane to the hydrogel side of the membrane. By adding CaCl₂), the water chemical potential on the surface of the hydrogel was reduced, thus initiating the transport of water through the membrane and to the interconnected water channels of the hydrogel.

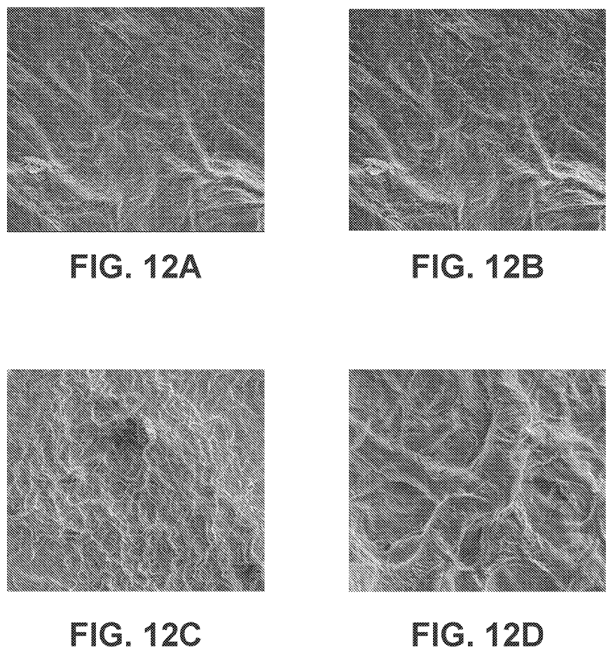

FIG. 12A illustrates an SEM image for a P-HG hydrogel, according to some embodiments. FIG. 12B illustrates an SEM image for a P-HG hydrogel, according to some embodiments. FIG. 12C illustrates an SEM image for a GO-HG hydrogel, according to some embodiments. FIG. 12D illustrates an SEM image for a GO-HG hydrogel, according to some embodiments. The hydrogel samples were coated with gold/palladium before the microscopy characterizations. Qualitative hydrophilicity tests were conducted using a SEM device in environmental mode. The humidity and the temperature were maintained at 100% and 5° C., respectively, throughout the tests. As shown in FIGS. 12A-12D, the surface of the P-HG appears to have a smoother morphology than the GO-HG. The GO-HG has additional 2D material (GO nanosheets) which causes the rougher morphology.

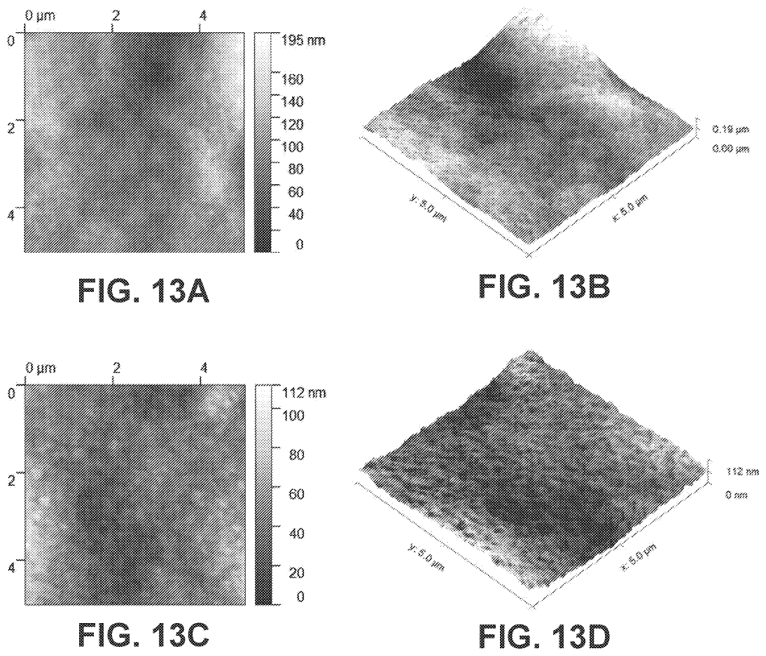

FIG. 13A illustrates an AFM image of a GO-HG hydrogel, according to some embodiments. FIG. 13B illustrates an AFM image of a GO-HG hydrogel, according to some embodiments. FIG. 13C illustrates an AFM image of a P-HG hydrogel, according to some embodiments. FIG. 13D illustrates an AFM image of a P-HG hydrogel, according to some embodiments. The average surface roughness of the GO-HG hydrogel was 29.69 nm (SD=5.96 nm) while that of the P-HG hydrogel was 14.28 nm (SD=2.58 nm). This suggests that the GO-HG hydrogel had a rougher surface than the P-HG hydrogel. These results are consistent with the surface morphology observations of the SEM images in FIGS. 12A-12D.

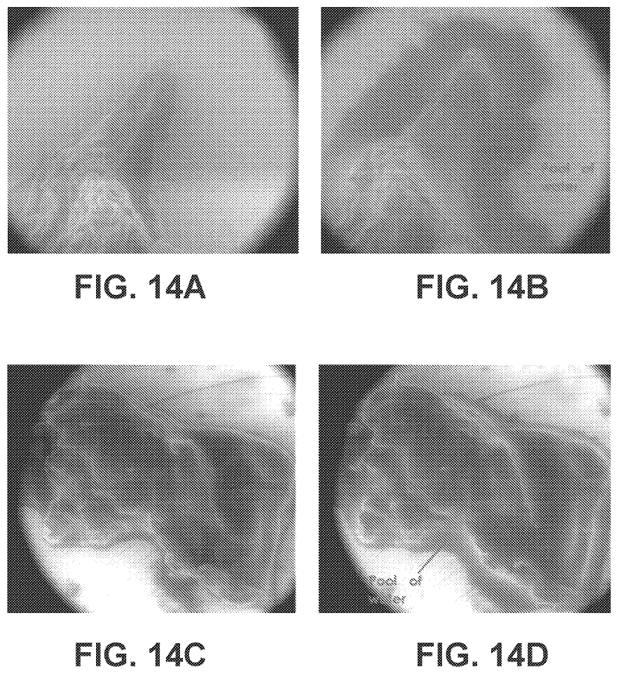

FIG. 14A illustrates a micrograph from E-SEM tests with a dry GO-HG hydrogel before the test, according to some embodiments. FIG. 14B illustrates a micrograph from E-SEM tests with a wet GO-HG hydrogel during the test, according to some embodiments. FIG. 14C illustrates a micrograph from E-SEM tests with a dry P-HG hydrogel before the test, according to some embodiments. FIG. 14D illustrates a micrograph from E-SEM tests with a wet P-HG hydrogel during the test, according to some embodiments. Surface interaction between the hydrogels and water vapor was observed using the environmental mode of a SEM. The relative humidity and the temperature were maintained at 100% RH and 5° C., respectively, throughout the tests. The micrographs in FIGS. 14A-14D show the changes in the hydrogel samples throughout the tests. From the images, it can be observed that after about 25 minutes, both hydrogel samples (GO-HG and P-HG) had a pool of water gathered around them, where the GO-HG showed a larger water pool relative to its sample size, whereas this gathered water is noticeably absent from the hydrogel samples at the beginning of the tests. These results serve as a qualitative demonstration of both hydrogels' affinity for water vapor. These hydrogels attracted the water vapor inside the E-SEM chamber, and then the water vapor condensed to liquid water, shown as dark shadows in the images.

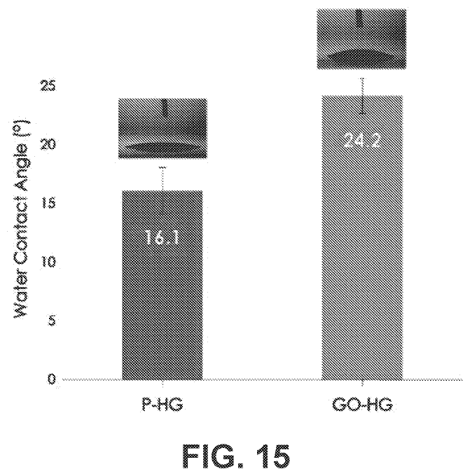

FIG. 15 illustrates the water contact angle results for P-HG and GO-HG hydrogels, according to some embodiments. Samples for the characterizations were prepared on glass slides. Six measurements were taken for each hydrogel sample, and the average was used as the final value. The mean water contact angle of the P-HG was 16.1±2.0° while that of the GO-HG was 24.2±1.5°. The obtained results demonstrate the high hydrophilicity of both hydrogels. Furthermore, the lower water contact angle for the P-HG suggests that its surface is more hydrophilic than the surface of the GO-HG.

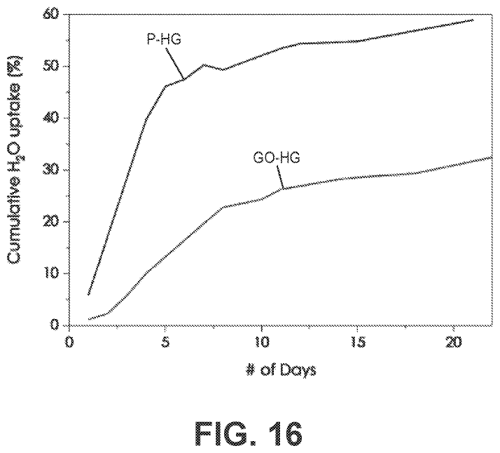

FIG. 16 illustrates water uptake results for P-HG and GO-HG hydrogels, according to some embodiments. Water uptake results show that the P-HG absorbed more water than the GO-HG within the same duration. Over a period of 22 days, the cumulative water uptake for the P-HG was 59% whereas that for the GO-HG was 32%. These results suggest that the P-HG had a higher capacity to contain water than the GO-HG. This may be from the higher hydrophilic nature of the PHG, resulting in a greater capacity for the P-HG to attract and absorb water. For a hydrophilic material, although an increase in surface roughness increases the hydrophilicity of the material surface, changes in the surface energy of the material can also affect the wettability of the material surface. For the GO-HG, the incorporation of GO increased the surface roughness of the hydrogel; however, a slight increase in the water contact angle was observed. Since an increase in the surface roughness was not accompanied by an increase in wettability, the lower wettability can therefore be attributed to changes in the surface chemistry, whose effects superseded those of the surface roughness and thus resulted in a net decrease in the surface hydrophilicity. Although GO nanosheets have polar hydrophilic functional groups on their oxidized edges and planes, there are still local areas of GO nanosheets that are uncharged, and the 2D sheet structure could also cover up some hydrophilic groups on the alginate polymer chains and result in an overall slightly less hydrophilic GO-HG.

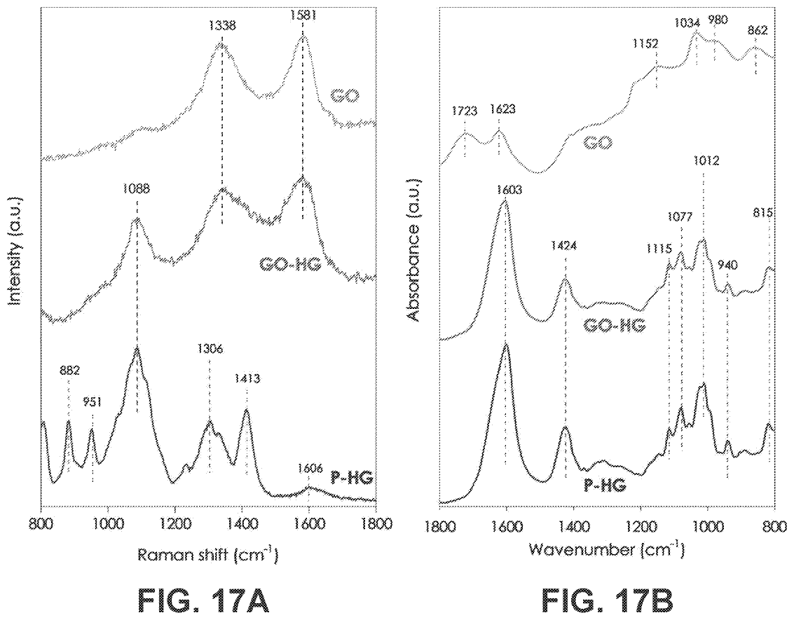

FIG. 17A illustrates Raman spectra for the GO, GO-HG, and P-HG hydrogel samples, according to some embodiments. The excitation wavelength used for the characterizations was 532 nm. Samples were prepared by applying drops of the sodium alginate solution (with and without GO) on glass slides and curing the solutions in 5% CaCl₂) to produce hydrogel films. The prepared samples were then rinsed with DI H₂O and dried in the air. Typical D and G bands of GO are present at 1338 and 1581 cm⁻¹, respectively. The characteristic bands for calcium alginate are shown in the spectrum of the P-HG hydrogel. It can be observed that in the spectrum for the GO-HG, the bands at 882, 951, and 1606 cm⁻¹ are not present. Furthermore, the bands at 345, 551, and 1088 cm⁻¹ are present in both the GO-HG and the P-HG spectra. Also, bands at 1338 and 1581 cm, which correspond to the D and G bands of GO, are present in the spectrum for GO-HG but absent from that of P-HG. This confirms the successful incorporation of GO into the GO-HG hydrogel.

FIG. 17B illustrates FTIR spectra for the GO, GO-HG, and P-HG hydrogel samples, according to some embodiments. FTIR spectroscopy characterizations were performed with an attenuated total reflectance accessory of a spectrometer in absorbance mode. The hydrogel samples were dried prior to the FTIR characterizations. The spectrum for GO shows characteristic C_O stretch, C—O—C asymmetric stretch, and epoxide stretch vibrations. The spectra for both the P-HG and the GO-HG are similar, and they both contain characteristic peaks for calcium alginate. Since there is no shift in the peaks of the P-HG and the GO-HG, it is likely that no new functional groups were formed in the GO-HG and the integration of GO into the hydrogel was achieved via physical means.

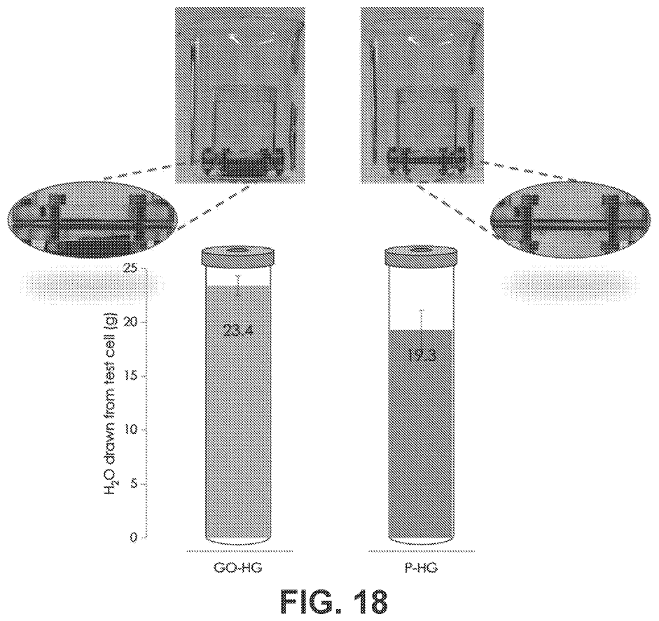

FIG. 18 illustrates water production results for the GO-HG and the P-HG hydrogels, according to some embodiments. Water production was quantitatively determined as the amount of water drawn by the hydrogel through an osmotic membrane over a 20-hour period. The results from these tests showed the mean water production to be 23.4±0.9 g and for the GO-HG hydrogel and 19.3±1.8 g for the P-HG. Despite the reported higher hydrophilic nature of the P-HG hydrogel, the amount of water produced by the GO-HG is significantly more than that produced by the P-HG. This observation is attributed to the incorporated flexible GO nanosheets, which provided hydrophilic functional sites and increased the interconnectivity within the alginate hydrogel framework, resulting in the better water production performance of the GO-HG. The interconnected GO networks provided additional channels and paths for water to flow unhindered through the hydrogel, thereby increasing the amount of water transported by the GO-HG. Unlike classic hydrogels that require external heat, pH changes, or pressure to release water, the hydrogels of the present disclosure can release water without external stimuli. The GO nanosheets are flexible and can partake in the formation of a polymeric network and easily achieve uniform distribution across the entire hydrogel. Different from most reported hydrogels that require external stimuli to undergo reversible volume change, water can be drawn through the membrane by the GO-HG and the P-HG in a continuous mode. No external stimulus is needed, and a hydrogel regeneration step is not required as the water flows through the interconnected water channels under gravitational force. It should be noted that the drawn water was not held within the hydrogels but was rather transported through the hydrogels and into the beaker for collection. The hydrogels are thus akin to conduits for transporting water. Therefore, there is no need for any dewatering step to recover the water drawn through the osmotic desalination membrane. This presents an advantage of using these hydrogels to draw water through osmotic membranes.

Osmotic pressure, which is a manifestation of chemical potential, is a primary driving force for water transport in osmotic membranes. The concentration difference of solutions at the osmotic membrane interface behaves as a negative hydraulic pressure in osmotic membranes. Therefore, the possible driving force for water transport in the osmotic membranes can be considered as a hydraulic pressure gradient.

Considering the test cell setup in FIG. 11, in which an osmotic membrane is placed between the DI H₂O and the hydrogel, a negative hydraulic pressure is responsible for the migration of water molecules through the osmotic membrane. Because there is no applied pressure on the DI H₂O in the test cell, a gradient of hydraulic pressure in the osmotic membrane toward the hydrogel is developed by the induced negative pressure at the interface with the hydrogel. Water moves from the DI H₂O side of the membrane to the hydrogel side of the membrane under this pressure gradient.

Additionally, the weight of the test cell over the hydrogel provides a gravitational force to expel the water from the hydrogel system. Consequently, the water drawn across the membrane will not be stored inside the hydrogel, but rather the water will flow freely through the interconnected water channels, allowing the continuous drawing of water without interruption. The presence of GO in the hydrogel improves the interconnectivity of the hydrophilic chains and makes the GO-HG more water-permeable than the P-HG, therefore enhancing the passage of water through the GO-HG. The abovementioned water production results suggest that the GO-HG and the P-HG can continuously draw water through a highly selective flat sheet cellulose triacetate (CTA) osmotic FO membrane owing to their permanent hydrophilic property and their stable structure. This shows the superiority of hydrogels over water-drawing solutions in maintaining the pressure gradient without being diluted by the permeated water. The hydrogel and selective osmotic membrane system can be used for water purification and desalination purposes.

The hydrogel and membrane system exhibited the capacity to continuously draw water through a selective flat sheet CTA FO osmotic desalination membrane owing to the hydrophilic surface property of the hydrogels and the GO nanosheet-enhanced hydrophilic chains structure. The GO-enhanced hydrogel combined with the membrane has the potential as an alternative solution for water purification and desalination without applying external pressure.

### Example 2

The earth's atmosphere holds large amount of water in the form of vapor or fine droplets due to the natural hydrological water cycle. These water resources can be harvested and serve as a possible solution for alternative water supply. However, to realize such a freshwater augmentation strategy, two technical challenges must be addressed: (1) design and fabricate an efficient moisture harvesting material that has high water uptake and little or no energy demand for water release; and (2) purify water to be safe for drinking by removing salinity, organic contaminants, bacteria, and viruses. Biopolymers, nanomaterials, and osmotically driven membrane processes can work together as a promising solution to meet such demands.

A design with two layers of alginate-GO or other functional hydrogel materials that are separated by a desalination osmotic membrane in the middle can purify atmospheric water. The hydrogel on the top is directly exposed to the air and can absorb the water vapor or moisture in the environment. In this way, atmospheric water is captured by hydrogel. Like Example 1, the hydrogels can be selected from an alginate P-HG hydrogel and an alginate GO-HG hydrogel. The hydrogels may include calcium alginate. The hydrogel on the bottom will draw accumulated water across the osmotic membrane and purify it into clean water. The atmospheric water capturing can be enhanced by adding a vacuum pump (manual or mechanical) to draw the wet air through the hydrogel on the top position and to promote more water moisture accumulating within the hydrogel. The device can work with or without the pump, with different atmospheric water capture rates.

Importantly, this design can capture atmospheric water efficiently with an optional vacuum pump. Further, the size and thickness of the hydrogels and osmotic membrane may be tuned according to the desired water production rates. This design can provide purified drinking without the need for an additional recovery or regeneration step. This device may be placed or contained within a variety of different apparatuses sufficient to hold the device together and facilitate water transfer. Importantly, the device may be created from natural materials.

### Example 3

Sodium alginate solution (1% w/v) may be prepared by dissolving 10 g of sodium alginate powder in 990 mL of DI H₂O. Then, 100 mL of the sodium alginate solution may be transferred to a beaker. Polyacrylic acid may be added to the sodium alginate solution. The polyacrylic acid utilized may have a molecular weight ranging from about 40,000 g/mol to about 110,000 g/mol. The polyacrylic acid concentration may range from about 0.05 M to about 0.2 M. There may be a set pH value utilized, such as 7 pH. Then, 40 mL of CaCl₂ (5% w/v) may be added to the 100 mL of sodium alginate solution and left to cure. Curing may include toughening by cross-linking of the polymer chains at room temperature for about 1-30 hours. For example, curing may be complete in about 20 hours. Finally, the resultant hydrogel may be rinsed with DI H₂O. Both the alginate and the polyacrylic acid can be cured by CaCl₂) under controlled pH.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

What is claimed is:

1. A device for water purification, the device comprising:
one or more first layers including a semipermeable membrane; and
one or more second layers in contact with the one or more first layers,
wherein the one or more second layers include an alginate hydrogel and are sufficient to draw water across the one or more first layers.

2. The device of claim 1, wherein the alginate hydrogel includes calcium alginate.

3. The device of claim 1, wherein the alginate hydrogel includes an anionic polymer.

4. The device of claim 3, wherein the anionic polymer includes polyacrylic acid.

5. The device of claim 1, wherein the one or more second layers further comprise an interconnected porous network; and wherein the one or more second layers include one or more of graphene oxide nanoparticles and graphene oxide nanosheets sufficient to increase the number of channels for the water to flow in the interconnected porous network.

6. The device of claim 1, wherein the semipermeable membrane includes a cellulose triacetate osmotic membrane.

7. The device of claim 1 further comprising one or more third layers, wherein the one or more third layers are on an opposite side of the semipermeable membrane from the one or more second layers.

8. A method of making a hydrogel, the method comprising:
contacting a first solution with calcium chloride to form a second solution; and
curing the second solution sufficient to form a hydrogel,
wherein the first solution includes sodium alginate solution.

9. The method of claim 8, wherein the first solution further includes one or more of graphene oxide nanoparticles and graphene oxide nanosheets.

10. The method of claim 9, wherein the graphene oxide nanosheets are present in a dispersion ranging from 1 g/L to 50 g/L.

11. The method of claim 8, wherein the first solution further includes an anionic polymer.

12. The method of claim 11, wherein the anionic polymer includes polyacrylic acid.

13. The method of claim 8, wherein the sodium alginate solution ranges from 0.5% w/v to 10% w/v.

14. The method of claim 8, wherein the calcium chloride ranges from 0.5% w/v to 15% w/v.

15. A method of water purification, the method comprising:
providing a semipermeable membrane in contact with one or more hydrogel layers; and
drawing unpurified water from a water source across the semipermeable membrane sufficient to purify the unpurified water,
wherein the one or more hydrogel layers include alginate and are more hydrophilic than the semipermeable membrane.

16. The method of claim 15, wherein the semipermeable membrane includes a cellulose triacetate osmotic membrane.

17. The method of claim 15, wherein the one or more hydrogel layers include one or more of calcium alginate, graphene oxide, and an anionic polymer.

18. The method of claim 15, wherein the one or more hydrogel layers include a first hydrogel layer on one side of the semipermeable membrane and a second hydrogel layer on the opposite side of the semipermeable membrane from the first hydrogel layer.

19. The method of claim 18, wherein the first hydrogel layer captures one or more of ambient water and atmospheric water; and wherein the second hydrogel layer draws accumulated water across the semipermeable membrane.

20. The method of claim 15, wherein purifying the unpurified water includes removing over 99% of contaminants from the unpurified water.
